(19) United States
(12) Patent Application Publication
(10) Pub. No.: US 2024/0340571 A1
(43) Pub. Date: Oct. 10, 2024

(54) METHOD FOR PARAMETERIZING A FILTER FOR ACTIVE NOISE CANCELATION OF A HEARING INSTRUMENT, METHOD FOR ACTIVE NOISE CANCELATION IN A HEARING INSTRUMENT, HEARING INSTRUMENT, AND METHOD FOR MODELING A SECONDARY FILTER

(71) Applicant: Sivantos Pte. Ltd., Singapore (SG)

(72) Inventor: Willem Alexander Klatt, Erlangen (DE)

(21) Appl. No.: 18/628,989

(22) Filed: Apr. 8, 2024

(30) Foreign Application Priority Data
Apr. 6, 2023 (DE) 10 2023 203 214.7
Jul. 19, 2023 (DE) 10 2023 206 841.9

(51) Int. Cl. H04R 1/10

(52) U.S. Cl. CPC H04R 1/1083; H04R 1/1016; H04R 2460/01

(57) ABSTRACT

A method for parameterizing a filter for active noise cancellation of a hearing instrument in an ear canal, includes configuring the filter to use an error signal of an in-ear microphone, recording sound containing noise in the ear canal, generating a correction signal for a loudspeaker directed into the ear canal, generating a correction sound during cancellation from the correction signal for compensating noise in the ear canal, and determining filter coefficients using an optimization problem. In the optimization problem, a sensitivity function dependent on filter coefficients and/or the filter, describing transmission of noise into the error signal, is weighted and optimized or minimized, with an objective weighting function. The optimization or minimization occurs under a secondary condition on the sensitivity function and/or a sensitivity function complementary thereto. The objective weighting function is given by a number of continuously differentiable or analytical functions, and has a bandpass characteristic.

### CROSS-REFERENCE TO RELATED APPLICATION

This application claims the priority, under 35 U.S.C. § 119, of German Patent Applications DE 10 2023 203 214.7, filed Apr. 6, 2023, and DE 10 2023 206 841.9, filed Jul. 19, 2023; the prior applications are herewith incorporated by reference in their entirety.

### FIELD AND BACKGROUND OF THE INVENTION

The invention relates to a method for parameterizing a filter for an, in particular non-adaptive, active noise cancelation of a hearing instrument which is to be worn by a user on their ear canal, wherein the filter is configured to use an error signal of an in-ear microphone of the hearing instrument to generate a correction signal for a loudspeaker of the hearing instrument directed into the ear canal, and filter coefficients of the filter are determined by an optimization problem. The invention also relates to a method for active noise cancelation in a hearing instrument, a hearing instrument, and a method for modeling a secondary filter.

In hearing instruments such as headphones, headsets, etc., but also hearing aids for treating a hearing impairment of a wearer, measures for active noise cancelation are increasingly being provided, which mostly suppress interfering sounds from the environment by a correction signal being output into the ear canal of the user via a loudspeaker of the hearing instrument. In that case, an ambient sound can be captured, e.g. by a microphone directed into the environment, in order to identify the noise signals present there for generating the correction signal. Alternatively, or, depending on the configuration, also in addition, a microphone directed into the ear canal can be used to directly capture the component of the noise signals that propagates on an acoustic transmission path past the hearing instrument (which usually largely closes off the entrance of the ear canal) into the ear canal.

In that context, a feature of great importance is the algorithm or filter used for the active noise cancelation, which generates the correction signal for the cancelation of the noise signals in the ear canal on the basis of an input signal of the microphone. In that case, on the one hand, the filter can be an adaptive filter, i.e. the filter parameters themselves depend on the input signal of the microphone to which the filter is applied. Such an adaptive filter often allows a rapid response to changes in the input signal, but artifacts or overshoots can also occur as a result of the filter parameters, which may vary greatly (and in some cases, poor convergence of the same).

On the other hand, the filter may also be static, i.e., the filter parameters are not dependent on the input signal of the microphone, so that the filter simulates substantially statically the transmission path of the noise into the ear canal (which is also largely time-independent, except for minimal changes due to jaw movements or the like of the user, which are negligible to a first approximation). Such a static filter avoids the above-mentioned problems of the convergence of the filter parameters. However, for the precision of the filter in the generation of the correction signal, the correct model for the simulation of the transmission path becomes all the more important.

### SUMMARY OF THE INVENTION

It is accordingly an object of the invention to provide a method for parameterizing a filter for active noise cancelation of a hearing instrument, a method for active noise cancelation in a hearing instrument, a hearing instrument, and a method for modeling a secondary filter, which overcome the hereinafore-mentioned disadvantages of the heretofore-known methods and instruments of this general type and with which a filter for an in particular non-adaptive active noise cancelation of a hearing instrument can be parameterized as simply and precisely as possible.

With the foregoing and other objects in view there is provided, in accordance with the invention, a method for parameterizing a filter for, in particular, non-adaptive active noise cancelation of a hearing instrument which is to be worn by a user on an ear canal, wherein the filter is configured to use an error signal of an in-ear microphone of the hearing instrument, which records a sound containing noise in the ear canal, to generate a correction signal for a loudspeaker of the hearing instrument directed into the ear canal, which in the operation of the active noise cancelation of the hearing instrument generates a correction sound from the correction signal for compensating the noise in the ear canal.

It is provided according to the method that filter coefficients of the filter are determined by using an optimization problem, wherein in the optimization problem a sensitivity function dependent on the filter coefficients and/or the filter, which describes a transmission of the noise into the error signal, is weighted and optimized, in particular minimized, with an objective weighting function, wherein the optimization, in particular minimization, is carried out under at least one secondary condition on the sensitivity function and/or on a sensitivity function complementary to the sensitivity function, and wherein the objective weighting function is given by a number of continuously differentiable, in particular analytical functions, and has a bandpass characteristic.

Advantageous embodiments, some of which are inventive in themselves, are the subject matter of the dependent claims and the following description.

A hearing instrument, in this case, generally refers to any device which is configured to generate a sound signal from an electrical signal—which can also be provided by an internal signal of the device—and to deliver the sound signal to the hearing system of a wearer of this device, in particular to a headphone (e.g. as an “earplug”), a headset, data glasses with a speaker, etc. A hearing instrument, however, also includes a hearing device in the narrower sense, that is, a device for treating a hearing impairment of the wearer, in which an input signal generated from an ambient signal by a microphone is processed into an output signal and amplified, in particular in a frequency band-dependent manner, and an output sound signal generated from the output signal by a loudspeaker or similar device is suitable for compensating for the hearing impairment of the wearer, at least partially, in particular in a user-specific manner.

When operated as intended, the hearing instrument is worn by a user “on” an ear canal, which means in particular that the hearing instrument is worn on an ear, thereby at least partially closing the ear canal from the outside, and/or partially penetrating the outer ear canal. Interfering sounds that reach the ear canal on an acoustic transmission path bypassing the hearing instrument are then to be compensated by the active noise cancelation by using the correction sound, which is output by the hearing instrument via its loudspeaker directed into the ear canal.

The in-ear microphone in this case is preferably also directed into the ear canal, i.e., if the hearing instrument closes the outer ear canal to a large extent apart from the acoustic transmission path, an “inside” and an “outside” are thereby defined with respect to the hearing instrument, wherein the “inside” relates to the largely closed ear canal, and the “outside” refers to the entire, free outside space.

Other features which are considered as characteristic for the invention are set forth in the appended claims.

Although the invention is illustrated and described herein as embodied in a method for parameterizing a filter for active noise cancelation of a hearing instrument, a method for active noise cancelation in a hearing instrument, a hearing instrument, and a method for modeling a secondary filter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of an active noise cancelation in a hearing instrument, which is worn on an ear canal of a person;

FIG. 2a is a diagram showing the dependence of a sigmoid function for various parameters in the exponent against the frequency;

FIG. 2b is a diagram showing the relationship between the signs of the prefactor and the parameter in the exponent of a sigmoid function;

FIG. 3 is a block diagram of a detailed embodiment of the filter of the active noise cancelation according to FIG. 1; and

FIG. 4 is a diagram showing a modeled objective weighting function for the filter according to FIG. 3 plotted against frequency, and a corresponding measured spectrum.

### DETAILED DESCRIPTION OF THE INVENTION

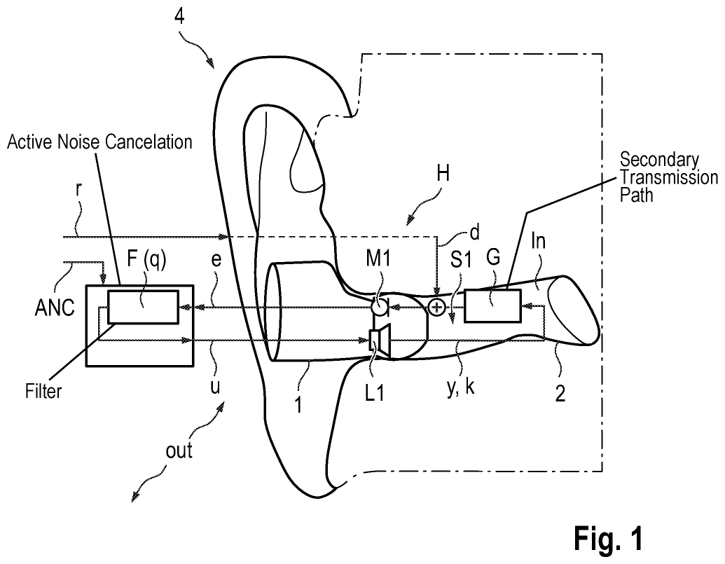

Referring now in detail to the figures of the drawings, in which equivalent parts and dimensions are provided with identical reference signs, and first, particularly, to FIG. 1 thereof, there is seen a block diagram of an active noise cancelation in a hearing instrument 1 with an in-ear microphone, which is worn on a person's ear canal 2, largely closing it off. By using this arrangement, with respect to the hearing instrument 1, an “inside” In is defined, which is formed by the ear canal 2 “beyond” the components of the hearing instrument 1, and an “outside” Out, which is formed by the free space starting at the ear 4.

The hearing instrument 1 has an in-ear microphone M1 and a loudspeaker L1, both of which are directed to the inside (In), i.e. into the ear canal 2, so that an output sound y generated by the loudspeaker L1 propagates in the direction of the eardrum (not shown) at the other end of the ear canal 2, and the in-ear microphone M1 receives a sound S1 in the ear canal 2, which also contains a noise signal d that is propagated on an acoustic transmission path H (dashed line) past the hearing instrument 1 from the outside (Out) into the ear canal 2. The noise d can be generated outside (Out) by any type of noise source as a noise r, e.g. by a motor of a vehicle or a machine such as traffic noise, fan noises or machine humming/buzzing, etc.

The acoustic transmission path H from the outside (Out) to the inside (In) into the ear canal 2 (e.g. for the propagation of the noise r into the ear canal 2 as the noise d) is also referred to as the primary transmission path. The transmission path from the loudspeaker L1 to the in-ear microphone M1 in the ear canal 2 itself is referred to as the secondary transmission path G, and may contain in particular resonances of the output sound y in the ear canal 2. In the present case, an output characteristic (i.e. a frequency response) of the loudspeaker L1 is assumed to be absorbed into the secondary transmission path G.

The in-ear microphone M1 now generates an input signal referred to as error signal e, on the basis of which a correction signal u is generated by an active noise cancelation ANC (which is shown here as a dashed block outside the hearing instrument 1 purely for reasons of space, but is physically implemented in the hearing instrument 1 on a suitable signal processor or a processor unit or similar). The correction signal u is converted by the loudspeaker L1 into a correction sound k, which is input into the output sound y. An A/D conversion of the error signal e or a D/A conversion of the correction signal u is assumed to be functionally absorbed into the in-ear microphone M1 or into the loudspeaker L1.

For the active noise cancelation ANC a filter F is applied to the error signal, which depends on filter coefficients q (coefficient vector), or can be parameterized via these.

The filter coefficients qₖ (entries k of the coefficient vector q) are determined according to the method by using an optimization problem in which a sensitivity function S, which describes the transfer of the noise d into the error signal e, is weighted with an objective weighting function W_{d} and then optimized (preferably minimized).

The sensitivity function thus describes what proportion of the noise d (which is produced by the external noise r and its propagation along the primary transmission path H) is input into the error signal e, which should take into account the fact that the error signal e itself depends on the correction signal u propagated along the secondary transmission path G.

If the filter F is described in terms of its dependence on the filter coefficients q as F (q), then the result obtained from FIG. 1 is:

$$e = d + G * u = d + F ( q ) * G * e , \qquad ( i )$$

where * is a convolution in the time domain (or discrete time domain). By applying a Z transformation to equation (i), the already mentioned relation between the error signal e and the noise d in the Z domain is obtained as:

$$E ( Z ) = S ( Z ) \cdot D ( Z ) = \frac{D ( Z )}{1 - F ( q , Z ) \cdot G ( Z )} . \qquad ( ii )$$

In order to obtain the filter parameters q, according to the method, the sensitivity function S (q, e^{jΩ}^{ₖ}) represented in equation (ii) is then weighted and minimized using the frequency-dependent objective weighting function W_{d} (e^{jΩ}^{ₖ}):

$${min}_{q} {‖ S ( q , {e}^{j {Ω}_{k}} ) {W}_{d} ( {e}^{j {Ω}_{k}} ) ‖}_{2}^{2} \qquad ( iii )$$

The minimization is performed in this case under a secondary condition on the sensitivity function S (q, e^{jΩ}^{ₖ}) and/or on a complementary sensitivity function T (q, e^{jΩ}^{ₖ}) with T (q, e^{jΩ}^{ₖ})=1−S(q, e^{jΩ}^{ₖ}) for all parameters q and all frequency arguments e^{jΩ}^{ₖ}.

The objective weighting function W_{d} (e^{jΩ}^{ₖ}) is chosen in such a way that it is given by a number of continuously differentiable and in particular analytical functions (of frequency), and also has a bandpass characteristic (the dependence on the frequency is expressed in the following on a case-by-case basis via e^{jΩ}^{ₖ} or via Ωₖ, depending on which representation is more advantageous).

Due to the present optimization problem and the corresponding choice of the objective weighting function, the filter for generating the correction signal of the active noise cancelation can be implemented in a particularly simple way, since no direct measurement is required on the actual person. Rather, the specific objective weighting function can be determined by statistical features that can be measured for a manageable number of test subjects and are then available to a plurality of users.

Preferably, the objective weighting function has a lower band limit in a frequency interval from 10 Hz to 100 kHz, particularly preferably from 40 Hz to 80 Hz, and/or an upper band limit in a frequency interval from 200 Hz to 800 kHz, particularly preferably from 400 Hz to 600 Hz, wherein the band limit is given in each case by the frequency at which a frequency response of the objective weighting function has fallen to half, based on the maximum value in dB. Outside the frequency ranges mentioned, active noise cancelation cannot be achieved satisfactorily with the given filter due to a loss of the phase relation in the ear canal, so that the frequency response of the objective weighting function, on the basis of which the filter is parameterized via the above-mentioned optimization problem, only needs to have significant components in the relevant range.

In particular, the frequency response of the objective weighting function has at least three turning points. This means that the objective weighting function which models the frequency response of typical noise signals has at least one plateau or hump-shaped region. The possibility of generating such a plateau in the objective weighting function allows an emphasis of a sub-frequency band within the actual bandpass range, in which the active noise cancelation is to be particularly effective.

The objective weighting function preferably contains a sum of an ascending, smoothed step function and a descending, smoothed step function, wherein the ascending and the descending smoothed step function are given by a sigmoid function or an arctangent or arc-cotangent function, respectively. These functions are particularly easy to parameterize and are also particularly stable in numerical procedures for implementing the optimization problem (iii).

Conveniently, the objective weighting function also includes a Gaussian function and/or a constant term. This provides additional degrees of freedom over the corresponding variables of the Gaussian function, which allow a particularly precise adjustment of the objective weighting function.

The objective weighting function W_{d} (Ωₖ) of the frequency argument Ωₖ thus advantageously has the following form:

$${W}_{d} ( {Ω}_{k} ) = {K}_{0} + \frac{{a}_{sig 1}}{1 + {e}^{{b}_{sig 1} {log}_{10} ( \frac{{Ω}_{k}}{{Ω}_{sig 1}} )}} + \frac{{a}_{sig 2}}{1 + {e}^{{b}_{sig 2} {log}_{10} ( \frac{{Ω}_{k}}{{Ω}_{sig 2}} )}} + {a}_{g} {e}^{- {b}_{g} {log}_{10}^{2} ( \frac{{Ω}_{k}}{{Ω}_{g}} )} , \qquad ( iv )$$

where K₀ is a constant term, wherein the amplitude parameters a_{sig1}, a_{sig2}, a_{g}, the frequency parameters Ω_{sig1}, Ω_{sig2}, Ω_{g} (preferably with Ω_{sig1}<Ω_{sig2}) and the slope parameters b_{sig1}, b_{sig2}, b_{g} are used for parameterizing the frequency response, and the products of a_{sig1} and b_{sig1} and of a_{sig2} and b_{sig2} have opposite signs. The second and third terms on the right-hand side of equation (iv) each represent sigmoid functions, and the fourth term is a Gaussian function.

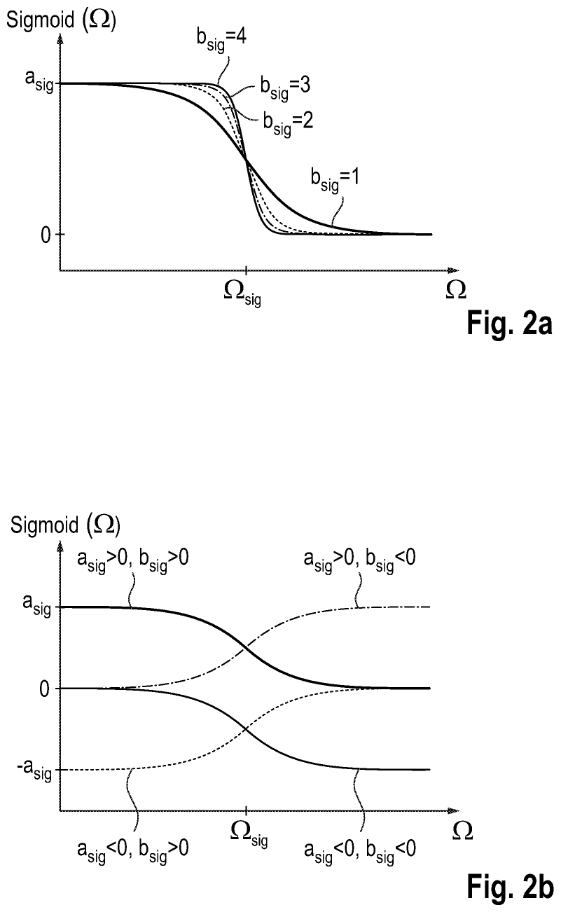

FIGS. 2a and 2b illustrate the relationships for individual parameters of the set mentioned herein. FIG. 2a (top left) shows the dependence of a sigmoid function on the frequency argument Ωₖ for different values of b_{sig}. As can be seen, the gradient becomes steeper as the parameter b_{sig} increases, and the step becomes shorter. This is comparable to the known relationship for Gaussian functions, which become narrower in the exponent (i.e. decreasing variance) with increasing parameter b_{g} and thus become more sharply peaked (as a result of the normalization). FIG. 2b (top right) shows the relationship between the signs of a_{sig} and b_{sig}. Clearly, an ascending sigmoid function is obtained when the two parameters have different signs, while for identical signs of a_{sig} and b_{sig} a descending sigmoid function is obtained.

Conveniently, the filter F (see FIG. 1) applied to the error signal e generates the correction signal u, wherein the filter F has a control filter Q and a secondary filter Ĝ, wherein the control filter Q is applied to a residual error signal eᵣₑₛ, from which, except for a constant factor, the correction signal u is generated, wherein the residual error signal eᵣₑₛ is generated based on a difference between the error signal e and the correction signal u fed-back and filtered with the secondary filter Ĝ, and wherein the coefficients of the control filter Q (q) are determined as the filter coefficients in the optimization. Preferably, the secondary filter Ĝ is selected in such a way that it simulates the secondary path G, which leads from the speaker L1 to the in-ear microphone M1 in the ear canal 2.

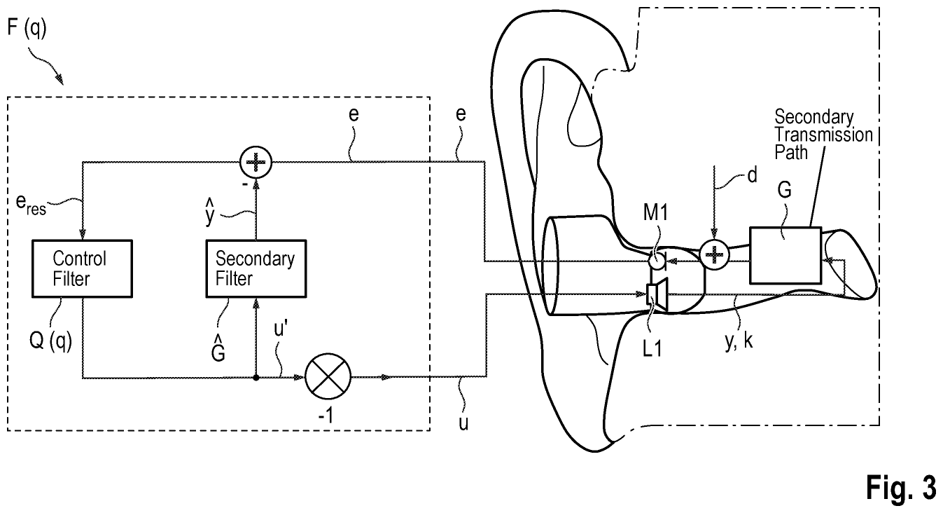

This is illustrated by reference to FIG. 3, which describes the filter F according to FIG. 1 schematically in a block diagram. Therefore, for the active noise cancelation ANC, the filter F (q) is applied to the error signal e, which has a control filter Q (q) and the secondary filter Ĝ. The control filter Q (q) is applied to the residual error signal eᵣₑₛ, from which the correction signal u is obtained except for a constant factor, which in the present case is selected as −1. The residual error signal eᵣₑₛ is generated in this case on the basis of the correction signal u′ (the factor −1 is only a phase) resulting from the control filter Q (q), to which the secondary filter Ĝ is applied. The resulting signal ŷ is subtracted from the error signal e to generate the residual error signal eᵣₑₛ.

It is advantageous to measure the secondary path as a function of frequency for a plurality of test persons in each case, wherein the secondary filter is formed as a function of frequency on the basis of the respective minimum over all secondary paths at the relevant frequency. Thus, one only has to take measurements for a relatively manageable number of test subjects (usually in the double-digit range), and one can then use the results for a large number of users (in the five- to six-digit range or even higher) in their respective hearing instruments.

Preferably, the secondary filter Ĝ(e^{jΩ}^{ₖ}) is formed as a function of the frequency Ωₖ as the secondary path of all the measured secondary paths (G) which has the greatest maximum over all observed frequencies,

$$\hat{G} ( {e}^{j {Ω}_{k}} ) = arg {max}_{G ∈ {𝒢}_{d}} {‖ G ( {e}^{j {Ω}_{k}} ) ‖}_{∞} ⇔ arg {max}_{G ∈ {𝒢}_{d}} {max}_{{Ω}_{k}} \vert G ( {e}^{j {Ω}_{k}} ) \vert , \\ k = 0 , … , {N}_{Ω} - 1 \qquad ( v )$$

where the set G_{d} denotes the set of all measured secondary paths, and No denotes the number of discrete frequencies. This is a particularly robust determination of the secondary filter Ĝ(e^{jΩ}^{ₖ}).

Alternatively, for each of the measured secondary paths Gₘ, a frequency-dependent limit function W_{G,m} (e^{jΩ}^{ₖ}) can be defined as:

$${W}_{G , m} ( {e}^{j {Ω}_{k}} ) = {max}_{G ∈ {𝒢}_{d}^{′}} \vert \frac{G ( {e}^{j {Ω}_{k}} ) - {G}_{m} ( {e}^{j {Ω}_{k}} )}{{G}_{m} ( {e}^{j {Ω}_{k}} )} \vert , m = 1 , … , {M}_{G} , \qquad ( vi )$$

where M_{G} is the number of test subjects, and the set G′_{d} denotes the set of the measured secondary paths without the secondary path m, wherein the secondary filter Ĝ(e^{jΩ}^{ₖ}) is formed as a function of the frequency argument e^{jΩ}^{ₖ} as the frequency-dependent minimum over all limit functions,

$$\hat{G} ( {e}^{j {Ω}_{k}} ) = arg {min}_{G ∈ {𝒢}_{d}} {‖ {W}_{G , m} ( {e}^{j {Ω}_{k}} ) ‖}_{∞} = arg {min}_{G ∈ {𝒢}_{d}} {sup}_{{Ω}_{k}} \vert {W}_{G , m} ( {e}^{j {Ω}_{k}} ) \vert$$

where the set G_{d} denotes the set of all measured secondary paths.

This means in particular: for each frequency e^{jΩ}^{ₖ} and each secondary path Gₘ (i.e. each measured secondary transmission path of an associated test subject m), the limit function W_{G,m} (e^{jΩ}^{ₖ}) is first formed as the value for which the modulus of the fraction assumes a maximum in equation (vi). This fraction represents the relative deviation from the secondary path Gₘ for all other measured secondary paths G, G∈G′_{d}. Once the maximum relative deviation of a different measured secondary path has been determined for each subject m and their measured secondary path Gₘ at each frequency e^{jΩ}^{ₖ}, these values form the limit function W_{G,m} (e^{jΩ}^{ₖ}).

Now, at each frequency e^{jΩ}^{ₖ}, the minimum value over all limit functions of the individual test subjects m is determined, see equation (vi), and the respective secondary path, at which the limit function becomes a minimum for a frequency e^{jΩ}^{ₖ}, is determined as the value of the secondary filter Ĝ(e^{jΩ}^{ₖ}) at this frequency e^{jΩ}^{ₖ}.

Advantageously, the sensitivity function S (q, e^{jΩ}^{ₖ}) is formed as a function of the filter coefficients q of the control filter Q and the frequency e^{jΩ}^{ₖ} and as a function of the secondary filter Ĝ(e^{jΩ}^{ₖ}) as:

$$S ( q , {e}^{j {Ω}_{k}} ) = 1 + Q ( {e}^{j {Ω}_{k}} ) \hat{G} ( {e}^{j {Ω}_{k}} ) .$$

This can be seen particularly clearly from FIG. 3.

The optimization problem conveniently has the following form:

$${min}_{q} {‖ S ( q , {e}^{j {Ω}_{k}} ) {W}_{d} ( {e}^{j {Ω}_{k}} ) ‖}_{2}^{2} \\ s . t . {‖ T ( q , {e}^{j {Ω}_{k}} ) {W}_{T} ( {e}^{j {Ω}_{k}} ) ‖}_{∞} < 1 \\ {‖ S ( q , {e}^{j {Ω}_{k}} ) {W}_{S} ( {e}^{j {Ω}_{k}} ) ‖}_{∞} < 1 \qquad ( vii )$$

Here, S denotes the sensitivity function, W_{d} the objective weighting function, q the vector of the filter coefficients, T the complementary sensitivity function (i.e. T=1-S), and W_{S} and W_{T} are frequency-based conditions for the sensitivity function or the complementary sensitivity function. The conditions W_{S} and W_{T} on S and T are formulated in the supremum norm.

For example, the sensitivity function S can be used to set the level of amplification of disturbances in general. For normalization reasons, the integral over the logarithm of |S (e^{jΩ}^{ₖ})| must be limited to <<1 up to a cutoff frequency. As a result, there will be ranges for |S (e^{jΩ}^{ₖ})| that are <1, and ranges where |S (e^{jΩ}^{ₖ})|>1 is true. In the latter case a disturbance is generally amplified (“disturbance amplification”). The specific form of S can then be used to set the frequency ranges up to which the system suppresses disturbances. These ranges are preferably to be matched to those frequency ranges in which the objective weighting function W_{d} occupies values substantially different from zero.

Preferably, the condition W_{T} is formed based on an analysis of the variance of a plurality of measured secondary paths, and/or the condition W_{S} is formed as a function of a nominal performance or an upper limit for noise amplification. The nominal performance is given in particular by the case in which the model for the secondary path simulates the actual secondary path.

The invention further specifies a method for active noise cancelation in a hearing instrument, in particular a hearing aid, and a hearing instrument which is configured for carrying out such a method for active noise cancelation.

For the method of active noise cancelation, by using an in-ear microphone of the hearing instrument in an ear canal of a user, a sound which contains a noise is converted into an error signal, wherein a correction signal is generated by a filter by using the error signal, wherein the correction signal is converted by a loudspeaker of the hearing instrument directed into the ear canal into a correction sound for compensating the noise, and wherein filter coefficients of the filter are parameterized by using the corresponding method described above. This includes in particular the fact that the filter coefficients q of a control filter Q are determined by using the optimization problem described above, preferably according to equation (iii) and in particular according to equation (vii).

The hearing instrument according to the invention includes an in-ear microphone which is configured to record a sound signal in a user's ear canal when the hearing instrument is worn by the user as intended, a loudspeaker which is directed into the ear canal when the hearing instrument is worn by the user as intended, and a signal processing unit, wherein the hearing instrument is configured to carry out the method for active noise cancelation.

The method according to the invention for active noise cancelation in a hearing instrument and the hearing instrument share the advantages of the method according to the invention for parameterizing a filter for active noise cancelation of a hearing instrument. The advantages mentioned for the latter method can be transferred, mutatis mutandis, to the method for active noise cancelation in a hearing instrument and to the hearing instrument.

The invention also specifies a method for modeling a secondary filter which simulates a secondary path that leads, in an ear canal of a user of a hearing instrument, from a loudspeaker of the hearing instrument disposed there to an in-ear microphone of the hearing instrument directed into the ear canal, wherein the secondary path is measured as a function of frequency for each of a plurality of test subjects, and wherein the secondary filter is formed as a function of frequency based on the respective minimum over all secondary paths at the relevant frequency.

Preferably, the secondary filter Ĝ(e^{jΩ}^{ₖ}) is formed as a function of the frequency argument e^{jΩ}^{ₖ} according to equation (v).

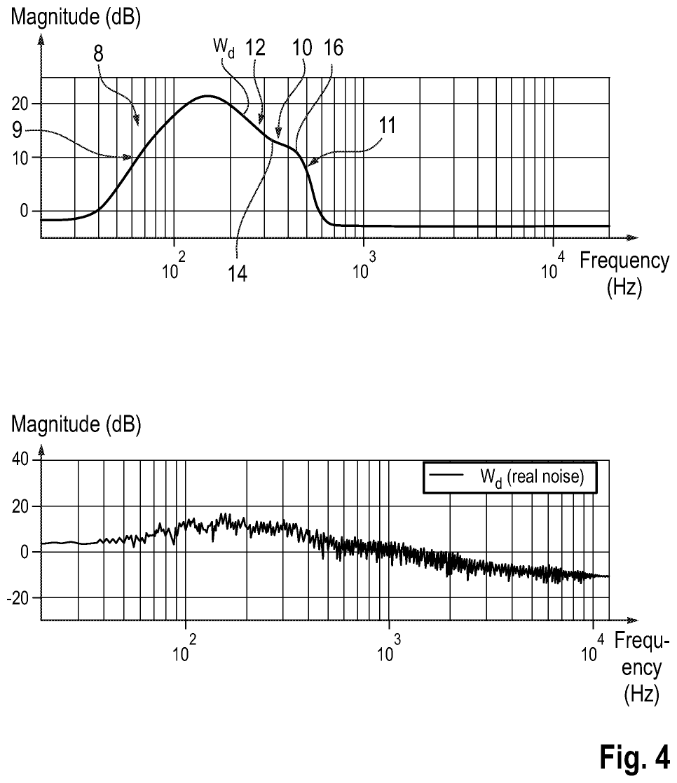

FIG. 4 shows an objective weighting function W_{d} plotted against frequency in the upper image, as is to be used for the above-mentioned optimization method. The objective weighting function W_{d} is of the form defined in equation (iv), wherein the rising edge 8 corresponds to the first sigmoid function (with a_{sig1}/b_{sig1}), and the falling edge 10 to the second sigmoid function (with a_{sig2}/b_{sig2}). The bulged portion 12, which contains an additional turning point 14 and leads into an indicated plateau 16, corresponds to the Gaussian function in equation (iv). The rising edge 8 represents a lower band limit 9 of the objective weighting function W_{d}, which in this case is localized in the region of approximately 65-70 Hz (decrease to half of the maximum value), the falling edge 10 represents an upper band limit 11 at approximately 500 Hz.

In the lower image of FIG. 4, a spectrum measured on a test subject for a noise process is shown. It can be clearly seen that the objective weighting function W_{d} has a more distinct bandpass behavior and is also significantly smoother, which greatly facilitates the parametrization of a filter.

Although the invention has been illustrated and described in greater detail by using the preferred exemplary embodiment, the invention is not restricted by the examples disclosed and other variations can be derived therefrom by the person skilled in the art without departing from the scope of protection of the invention.

The following is a summary list of reference numerals and the corresponding structure used in the above description of the invention.

### LIST OF REFERENCE SIGNS

1 hearing instrument
2 ear canal
4 ear
8 rising edge
9 lower band limit
10 falling edge
11 upper band limit
12 bulged portion
14 additional turning point
16 indicated plateau
ANC active noise cancelation
d noise (in the ear canal)
e error signal
eᵣₑₛ residual error signal
F filter
G secondary transmission path
Ĝ secondary filter
H primary (acoustic) transmission path
In inside
k correction sound
L1 loudspeaker
M1 in-ear microphone
Out outside
Q control filter
q filter coefficients
r noise
S1 sound (in the ear canal)
u correction signal
W_{d} objective weighting function
y output sound
ŷ resulting signal (from secondary filter)

1. A method for parameterizing a filter for active noise cancelation of a hearing instrument to be worn by a user on an ear canal, the method comprising:
configuring the filter to use an error signal of an in-ear microphone of the hearing instrument, the error signal recording a sound containing noise in the ear canal to generate a correction signal for a loudspeaker of the hearing instrument directed into the ear canal, and the loudspeaker during operation of the active noise cancelation of the hearing instrument generating a correction sound from the correction signal for compensating the noise in the ear canal;
determining filter coefficients of the filter by using an optimization problem;
in the optimization problem, weighting and optimizing or minimizing with an objective weighting function, a sensitivity function dependent on at least one of the filter coefficients or the filter and describing a transmission of the noise into the error signal;
carrying out the optimization or minimization under at least one secondary condition on at least one of the sensitivity function or a sensitivity function complementary to the sensitivity function;
giving the objective weighting function by a number of continuously differentiable or analytical functions; and
providing the objective weighting function with a bandpass characteristic.

2. The method according to claim 1, which further comprises providing the objective weighting function with at least one of:
a lower band limit in a frequency interval from 10 Hz to 100 kHz, or
an upper band limit in a frequency interval from 200 Hz to 800 kHz,
the lower or upper band limit being given by a frequency at which a frequency response of the objective weighting function has fallen to half, relative to a maximum value in dB.

3. The method according to claim 1, which further comprises:
providing the objective weighting function with a sum of an ascending, smoothed step function and a descending, smoothed step function; and
the ascending and the descending smoothed step functions being given by a sigmoid function or an arctangent or arc-cotangent function, respectively.

4. The method according to claim 3, which further comprises including at least one of a Gaussian function or a constant term in the objective weighting function.

5. The method according to claim 4, which further comprises:
providing the objective weighting function Wd (Ωk) of the frequency argument Ωk with a following form:
$${W}_{d} ( {Ω}_{k} ) = {K}_{0} + \frac{{a}_{sig 1}}{1 + {e}^{{b}_{sig 1} {log}_{10} ( \frac{{Ω}_{k}}{{Ω}_{sig 1}} )}} + \frac{{a}_{sig 2}}{1 + {e}^{{b}_{sig 2} {log}_{10} ( \frac{{Ω}_{k}}{{Ω}_{sig 2}} )}} + {a}_{g} {e}^{- {b}_{g} {log}_{10}^{2} ( \frac{{Ω}_{k}}{{Ω}_{g}} )} , {Ω}_{sig 1} < {Ω}_{sig 2}$$
where K0 is a constant term; and
amplitude parameters asig1, asig2, ag, frequency parameters Ωsig1, Ωsig2, Ωg and slope parameters b sig1, bsig2, bg are used for parameterizing a frequency response, and products of asig1 and bsig1 and of asig2 and bsig2 have opposite signs.

6. The method according to claim 1, which further comprises:
using the filter applied to the error signal to generate the correction signal;
providing the filter with a control filter and a secondary filter;
applying the control filter to a residual error signal and generating the correction signal therefrom, except for a constant factor;
generating the residual error signal by a difference between the error signal and the correction signal, fed back and filtered by the secondary filter; and
determining the filter coefficients in the optimization by coefficients of the control filter.

7. The method according to claim 6, which further comprises selecting the secondary filter to simulate a secondary path leading from the loudspeaker to the in-ear microphone in the ear canal.

8. The method according to claim 7, which further comprises:
measuring the secondary path as a function of frequency for each of a plurality of test subjects; and
forming the secondary filter as one secondary path out of all of the measured secondary paths having a greatest maximum over all observed frequencies.

9. The method according to claim 6, which further comprises forming the sensitivity function S (q, e^{jΩ}^{ₖ}) as a function of the filter coefficients q of the control filter Q and the frequency argument e^{jΩ}^{ₖ} and as a function of the secondary filter Ĝ(e^{jΩ}^{ₖ}) as:
$$S ( q , {e}^{j {Ω}_{k}} ) = 1 + Q ( {e}^{j {Ω}_{k}} ) \hat{G} ( {e}^{j {Ω}_{k}} ) .$$

10. The method according to claim 1, which further comprises providing the optimization problem with the following form:
$${min}_{q} {‖ S ( q , {e}^{j {Ω}_{k}} ) {W}_{d} ( {e}^{j {Ω}_{k}} ) ‖}_{2}^{2} \\ s . t . {‖ T ( q , {e}^{j {Ω}_{k}} ) {W}_{T} ( {e}^{j {Ω}_{k}} ) ‖}_{∞} < 1 \\ {‖ S ( q , {e}^{j {Ω}_{k}} ) {W}_{S} ( {e}^{j {Ω}_{k}} ) ‖}_{∞} < 1$$
where S denotes the sensitivity function, Wd denotes the objective weighting function, q denotes the vector of the filter coefficients, T denotes the complementary sensitivity function (i.e. T=1−S), and WS and WT denote frequency-related conditions for the sensitivity function or the complementary sensitivity function.

11. The method according to claim 10, which further comprises at least one of:
forming the condition WT by an analysis of a variance of a plurality of measured secondary paths, or
forming the condition WS as a function of a nominal performance or an upper limit for a noise amplification.

12. A method for active noise cancelation in a hearing instrument or a hearing aid, the method comprising:
converting a sound containing a noise into an error signal by using an in-ear microphone of the hearing instrument in an ear canal of a user;
utilizing a filter using the error signal to generate a correction signal;
using a loudspeaker of the hearing instrument directed into the ear canal to convert the correction signal into a correction sound for compensating the noise; and
parameterizing filter coefficients of the filter by using the method according to claim 1.

13. A hearing instrument, comprising:
an in-ear microphone configured to record a sound in the user's ear canal when worn as intended;
a loudspeaker directed into the ear canal when worn as intended by the user; and
a signal processing unit;
the hearing instrument configured to carry out the method according to claim 12.

14. A method for modeling a secondary filter simulating a secondary path leading, in an ear canal of a user of a hearing instrument, from a loudspeaker of the hearing instrument disposed in the ear canal to an in-ear microphone of the hearing instrument directed into the ear canal, the method comprising:
measuring the secondary path as a function of frequency for a plurality of subjects; and
forming the secondary filter as a function of frequency, based on a respective minimum over all of a plurality of secondary paths at a relevant frequency.

15. The method according to claim 14, which further comprises forming the secondary filter Ĝ(e^{jΩ}^{ₖ}) as a function of the frequency Ωk as the path of all of the measured secondary paths having a greatest maximum over all observed frequencies,
$$\hat{G} ( {e}^{j {Ω}_{k}} ) = arg {max}_{G ∈ {𝒢}_{d}} {‖ G ( {e}^{j {Ω}_{k}} ) ‖}_{∞} ⇔ arg {max}_{G ∈ {𝒢}_{d}} {max}_{{Ω}_{k}} \vert G ( {e}^{j {Ω}_{k}} ) \vert , k = 0 , … , {N}_{Ω} - 1$$
wherein a set Gd denotes a set of all measured secondary paths, and NΩ denotes a number of discrete frequencies.
